(19) United States
(12) Patent Application Publication
(10) Pub. No.: US 2017/0354158 A1
(43) Pub. Date: Dec. 14, 2017

(54) Apparatus, Systems and Methods for Minimizing Lipid Oxidation in Food Product

(71) Applicant: West Liberty Foods, West Liberty, IA (US)

(72) Inventors: Jin-Shan Shie, Hayward, CA (US); Lee Johnson, West Liberty, IA (US); Scott Schallenberger, Tremonton, UT (US)

(21) Appl. No.: 15/623,027

(22) Filed: Jun. 14, 2017

Related U.S. Application Data
(60) Provisional application No. 62/349,775, filed on Jun. 14, 2016.

(51) Int. Cl. A23B 4/18; A23L 3/3418; A23B 4/01; A23B 4/005

(52) U.S. Cl. CPC A23B 4/18; A23B 4/0056; A23L 3/3418; A23B 4/01

(57) ABSTRACT

The disclosed apparatus, systems and methods relate to apparatus, systems and methods for minimizing lipid oxidation in products such as food products including tuna salad.

### CROSS-REFERENCE TO RELATED APPLICATION(S)

This application claims priority to U.S. Provisional Application No. 62/349,775, filed Jun. 14, 2016 and entitled “Apparatus, Systems and Methods for Minimizing Lipid Oxidation in Food Product,” which is hereby incorporated by reference in its entirety under 35 U.S.C. §119(e).

### FIELD OF THE INVENTION

The disclosure relates to devices, systems and methods for product processing to prevent lipid oxidation.

### BACKGROUND

Extended refrigerated shelf life, greater than 30 days, of oxidation susceptible products such as fish has been an industry challenge. The ability to produce cooked, packaged fish, tuna, with extended shelf life in a food safe and organoleptically acceptable fashion is anticipated to open up new markets for this type of product.

### BRIEF SUMMARY

Discussed herein are various aspects and embodiments of devices, systems and methods for food processing. More specifically, various implementations relate to tuna salad processing systems, devices, and methods.

One general aspect includes a method for minimizing lipid oxidation in a food product, including preparing an antioxidant solution, treating the food product with the antioxidant solution so as to mix the antioxidant solution into the product, and removing excess antioxidant solution from the product, where the treated product is vacuum-packed and cooked prior to removing excess antioxidant solution from the product.

Implementations may include one or more of the following features. The method where the antioxidant solution is a Kalsec Duralox® 6207.13 antioxidant solution at about 5%. The method the antioxidant solution including an antioxidant concentration in water of about 0% to about 10%. The method where the treated product is portioned and vacuum packed in cook-in high oxygen barrier bags. The method further including placing the product in a water bath at about 204, such that the product reaches about 194 and is held at about 194 for about 10 min. The method further including chilling the product after cooking in a water bath to bring the temperature of the product from about 120 to about 55 within about 6 hours and then continued to chill until the product reaches about 40. The method further including chilling the product, after cooking, is chilled to below 40 but above 32. The method further including adding an ingredient to the product. The method where the mixing tumbles the food product and antioxidant solution in a tumbler. The method further including vacuum tumbling the antioxidant and thawed product for about 5 minutes at about 3 rpm. The method where the food product to antioxidant solution ratio is about 3.0 to about 0.7. The method where undiluted antioxidant is directly added to the product and water is added subsequently. The method where the removing includes removing excess antioxidant solution from the product by mechanical force. The method where the removing excess antioxidant is achieved by pressing the product, centrifuging the product or employing a salad spinner to mix the product. The method further including vacuum packing the product into high oxygen barrier bags to produce a final product. The method where the product is packed under a modified atmosphere. The method where the step prolonging the product shelf-life includes of at least one finishing process selected from the group including of pasteurizing the product, omega heating the product, irradiating the product, UV light pasteurizing the product and steam treating the product.

One general aspect includes a method for minimizing lipid oxidation in a food product, including treating the food product with an antioxidant solution, mixing the antioxidant solution into the product, and removing excess antioxidant solution from the product. The method also includes where the product is treated with the antioxidant throughout.

Implementations may include one or more of the following features. The method where the mixing tumbles the food product and antioxidant solution in a tumbler. The method further including vacuum tumbling the antioxidant and thawed product for about 5 minutes at about 3 rpm. The method where the food product to antioxidant solution ratio is about 3.0 to about 0.7. The method where undiluted antioxidant is directly added to the product and water is added subsequently. The method where the removing includes removing excess antioxidant solution from the product by mechanical force. The method where the removing excess antioxidant is achieved by pressing the product, centrifuging the product or employing a salad spinner to mix the product. The method further including vacuum packing the product into high oxygen barrier bags to produce a final product. The method where the product is packed under a modified atmosphere. The method where the step prolonging the product shelf-life includes of at least one finishing process selected from the group including of pasteurizing the product, omega heating the product, irradiating the product, uv light pasteurizing the product and steam treating the product.

One general aspect includes a method for minimizing lipid oxidation in a food product via several steps, the steps including preparing an antioxidant solution, treating the food product with the antioxidant solution, mixing the antioxidant solution into the product, and removing excess antioxidant solution from the product.

Implementations may include one or more of the following features. The method where the removing includes removing excess antioxidant solution from the product by mechanical force. The method where the removing excess antioxidant is achieved by pressing the product, centrifuging the product or employing a salad spinner to mix the product. The method further including vacuum packing the product into high oxygen barrier bags to produce a final product. The method where the product is packed under a modified atmosphere. The method where the step prolonging the product shelf-life includes at least one finishing process selected from the group including of pasteurizing the product, omega heating the product, irradiating the product, UV light pasteurizing the product and steam treating the product.

One general aspect includes a method for minimizing lipid oxidation in a food product via several steps, the steps including preparing an antioxidant solution, treating the food product with the antioxidant solution, mixing the antioxidant solution into the product, removing excess antioxidant solution from the product, and prolonging the shelf-life of the product.

Implementations may include one or more of the following features. The method where the step prolonging the product shelf-life includes at least one finishing process selected from the group including of pasteurizing the product, omega heating the product, irradiating the product, UV light pasteurizing the product and steam treating the product.

While multiple embodiments are disclosed, still other embodiments of the disclosure will become apparent to those skilled in the art from the following detailed description, which shows and describes illustrative embodiments of the disclosed apparatus, systems and methods. As will be realized, the disclosed apparatus, systems and methods are capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 depicts a flow chart of an exemplary embodiment of an oxidation minimization system, according to one embodiment.

FIG. 2 depicts a top view of a frozen product prior to undergoing implementation of the process, according to one embodiment.

FIG. 3 depicts the side view of an antioxidant solution, according to one embodiment.

FIG. 4A depicts a top view of the thawed product and antioxidant solution in a tumbler, according to one embodiment.

FIG. 4B depicts the side view of the tumbler, according to one embodiment.

FIG. 5A depicts a top view of the treated product before packaging, according to one embodiment.

FIG. 5B depicts a top view of the treated, vacuum-packed product, according to one embodiment.

FIG. 6A depicts a side view of the treated, vacuum-packed product assembled in the cooking step, according to one embodiment.

FIG. 6B depicts the side view of the tank used in the cooking step, according to one embodiment.

FIG. 6C depicts a side view of the water bath used in the cooking step, according to one embodiment.

FIG. 7A depicts a top view of a cooked product following the chilling step, according to one embodiment.

FIG. 7B depicts the top view of a cooked product following the removal step, according to one embodiment.

FIG. 8A depicts the top view of a pressed product combined with further ingredients, according to one embodiment.

FIG. 8B depicts the top view of the final product following optional high pressure pasteurization, according to one embodiment.

### DETAILED DESCRIPTION

The various embodiments disclosed or contemplated herein relate to methods, systems, and devices for the preparation of protein products. Namely, various implementations relate to the technology providing for an oxidation minimization system in food products, and other proteins, such as the non-limiting examples of meat, including beef, pork, and seafood including fish and fish having high fatty acid content. For example, in certain specific embodiments, the fish is tuna. It is understood that many other proteins can be used, however, including other known fishes, seafoods and meats or meat-substitutes such as soy. It is further understood that lipid oxidation is the primary cause of irregular flavor and quality degradation in fish and these other seafood products. Lipid oxidation is particularly disruptive in fish with high fatty acid content, such as salmon and tuna.

Lipid oxidation is caused by the presence of oxygen and energy around a lipid-rich substance, and typically occurs in three phases: initiation, propagation, and termination. An approach to preventing or minimizing lipid oxidation is to prevent or reduce the formation of free radicals at the early stage, which in this instance refers to the time frame “immediately” post thawing. Within an 8-12 hour window of time between thawing and application of antioxidant solution, the disclosed embodiments prevent or minimize the formation of free radicals during the cooking and storage of a food product, such as tuna lions and other seafood having high fatty acid content.

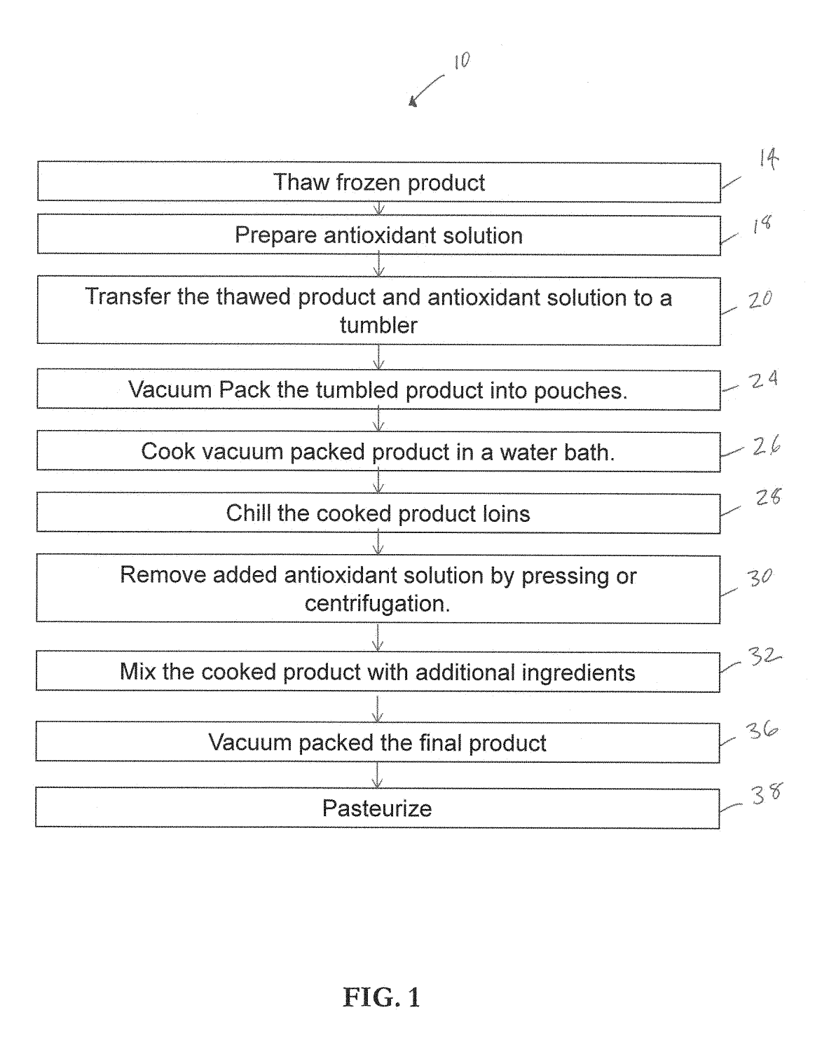

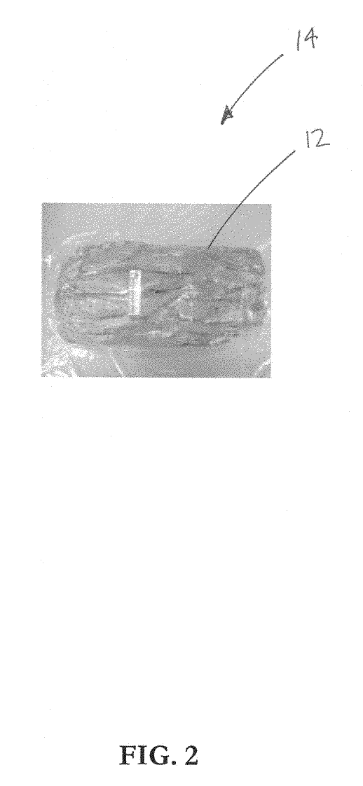

In accordance with certain implementations, the system introduces an antioxidant into the product. Known antioxidant solutions can be sprayed onto the surface of a food product to prevent oxidation, but this known technique does not adequately prevent oxidation inside the product. In contrast, the various system embodiments disclosed or contemplated herein include steps and processes which are able to prevent lipid oxidation not just on the surface of the food product (such as tuna loins) but throughout the entire food product, including internal portions thereof. Various implementations and examples of the disclosed systems, methods and associated devices are described below. FIG. 1 depicts a flow chart of an exemplary embodiment of an oxidation minimization system 10. FIGS. 2-8B depict detailed views of the various steps of the system, according to exemplary embodiments. As will be appreciated by one of skill in the art, these preparation implementations can comprise a number of optional steps executed in any order.

In the embodiment of FIG. 1, a frozen food product (such as the frozen product 12 depicted in FIG. 2) is first thawed in a liquid bath (box 14). In certain embodiments, a liquid brine chiller can be utilized, such as an Alkar® liquid brine chiller. In one implementation, the bath temperature is set to 40 degrees Fahrenheit. In certain implementations, a thaw time of 16 hours is employed, though various other combinations of temperature and time can be utilized, as would be apparent to one of skill in the art.

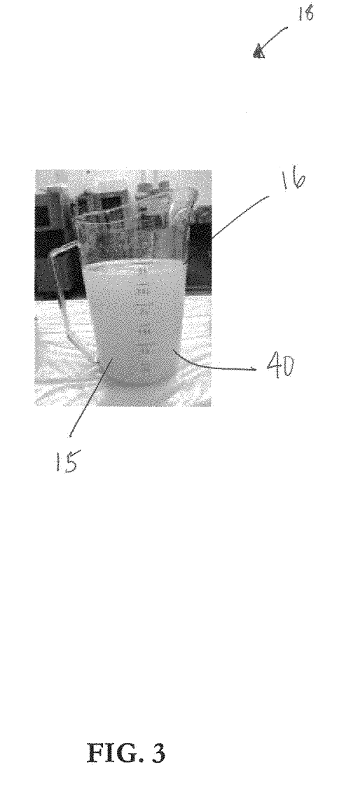

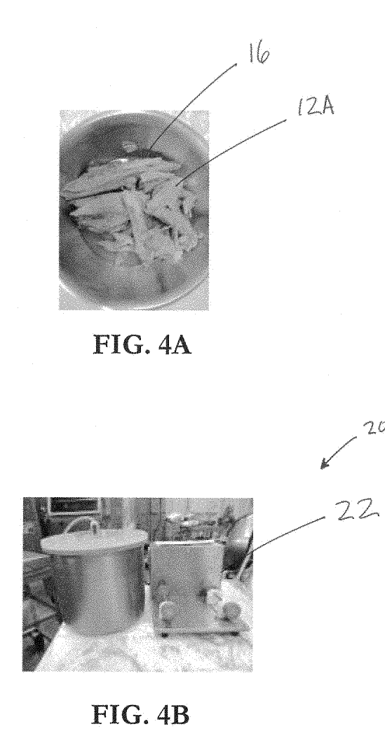

Continuing with FIG. 1, an antioxidant solution is prepared (box 18), such as preparation of the antioxidant solution 16 as discussed in further detail below in relation to FIG. 3. After the product is thawed (box 14) and the antioxidant solution is prepared (box 18), the thawed product and solution are transferred to a tumbler to treat the product (box 20). Alternatively, any treatment method can be used to treat the product with the antioxidant. The treatment of a food product 12A with an antioxidant solution 16 is discussed in further detail below in relation to FIGS. 4A-B, including exemplary embodiments in which a vacuum tumbler 22 is used for treatment.

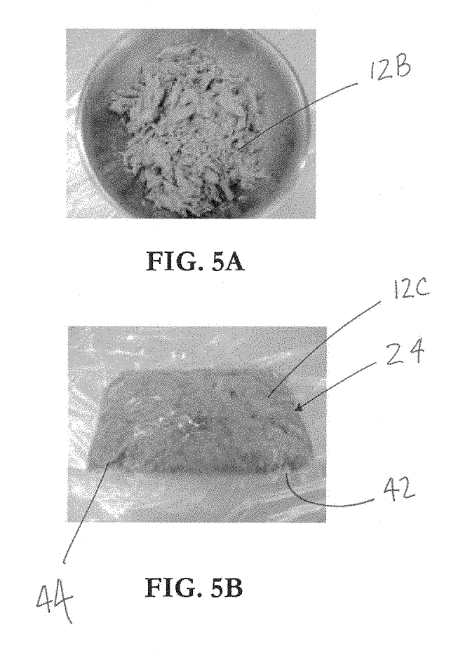

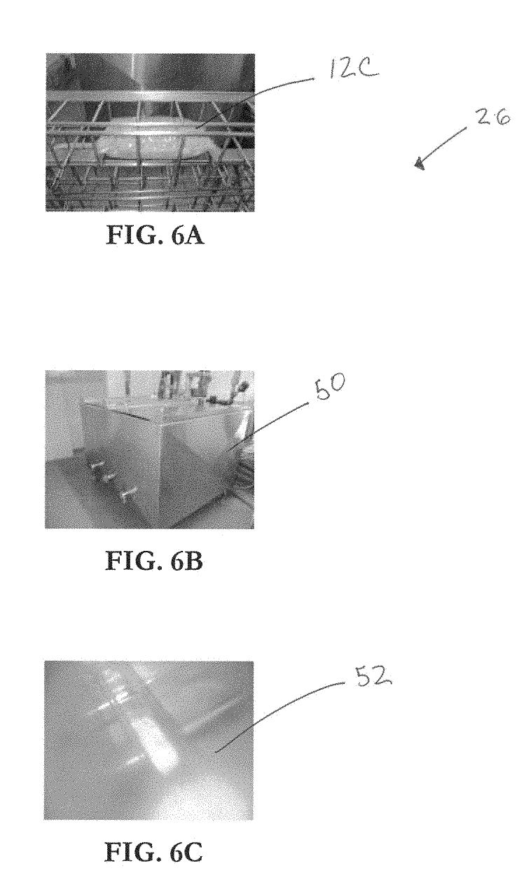

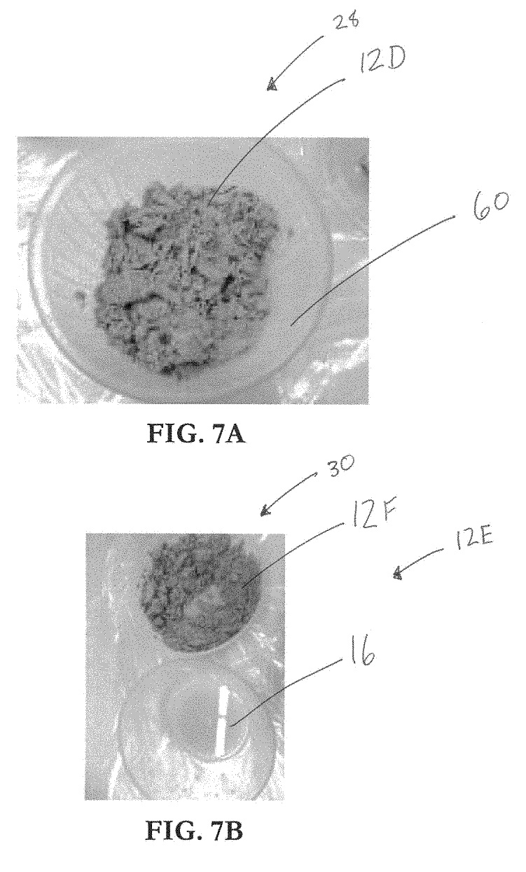

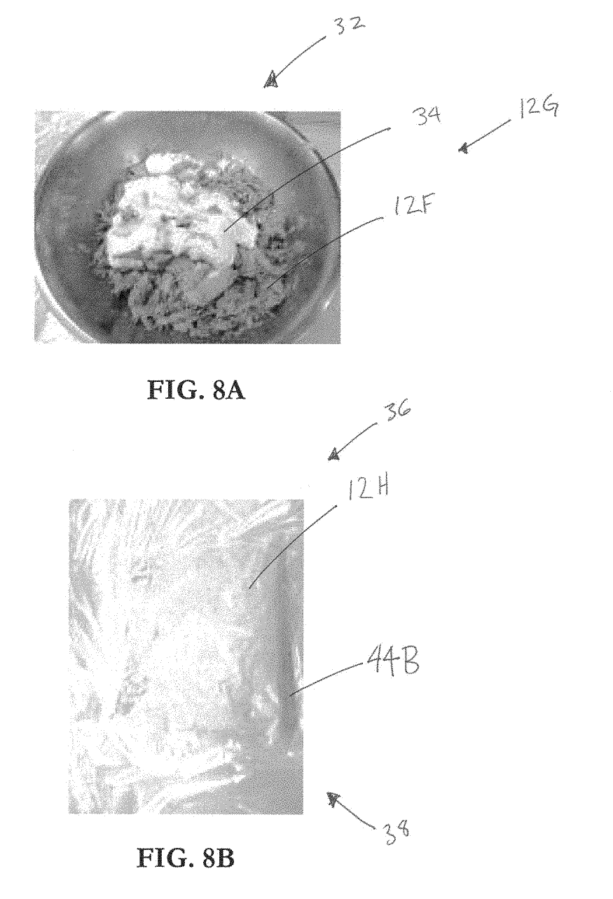

Continuing further with FIG. 1, after the product has been transferred to a tumbler and treated (box 20), the treated product is vacuum packed into pouches (box 24) (for example, as is discussed in further detail below with respect to treated product 12B in relation to FIGS. 5A-B). The treated and packaged product is then cooked in a water bath (box 26). For example, according to one embodiment, a treated and packed product 12C is cooked in a water bath 52 in tank 50 as discussed in detail below with respect to FIGS. 6A-6C. The cooked product is then chilled (box 28). One embodiment of this step in which the cooked product 12D is chilled is discussed below in addition detail in relation to FIG. 7A. Subsequently, the antioxidant solution is removed from the chilled product by pressing or centrifugation (box 30). For example, in one implementation, the antioxidant solution 16 is removed from the chilled product 12D in a removal step (box 30) as described in further detail below and shown in FIG. 7B. Finally, the processed product can be mixed with further ingredients (box 32), vacuum packed (or otherwise packaged) (box 36), and pasteurized (box 38). One implementation of these steps in which a processed product 12E is mixed with other ingredients, including mayonnaise 34, and the final product 12H is pasteurized using high pressure pasteurization (“HPP”) is discussed below in additional detail in relation to FIGS. 8A-8B.

FIG. 2 depicts an exemplary embodiment of the frozen product 12 prior to undergoing one implementation of the process. In exemplary embodiments, in the thawing step (box 14 of FIG. 1), the frozen product 12 can be thawed (box 14) in a tank with running water to 30° F. In various embodiments, a liquid brine temperature set at 40° F. can be used with a 16 hour thawing time in an Alkar® liquid brine chiller, which in certain implementations has the dimensions 14.5″×8.25″×3.75″. In alternative embodiments, final backbone temperatures up to 50° F. can be used. Alternatively, any known tank for thawing a frozen food product can be used, and any known temperatures and/or time periods can be applied for completing the thawing process.

The thawing step (such as block 14 of FIG. 1) of the system 10 can reduce histamine accumulation in the thawed product 12A. Frequently, histidine decarboxylase can be produced by certain bacteria during warming. Histidine decarboxylase is an enzyme which reacts with naturally-occurring histidine in the frozen product 12 as it thaws to produce scombrotoxin, a histamine, particularly at higher temperatures. Histamine can cause illness when it is consumed at a levels above 200 ppm and often above 500 ppm. Accordingly, in many embodiments, it is advisable to keep the temperature of product 12 below 40° F. to minimize the formation of histamine. Accordingly, frozen product 12, such as tuna loins, can be thawed in a running water bath to minimize the growth of microorganisms and histamine formation, where the temperature of the water is kept under 40° F. In alternative embodiments, the frozen product 12 can also be thawed in a microwave, at higher temperatures such as about 40° F. to about 140° F., and/or in temperature controlled rooms with or without forced air.

In further alternatives, the product may not be pre-warmed or cooked prior to proceeding with the antioxidant treatment of FIGS. 3-4. Here, “prewarmed” refers to temperatures above 40-50° F. Loins are thawed in the manner described earlier in this document.

FIG. 3 depicts one embodiment of the step of preparing an antioxidant solution (box 18 of FIG. 1). In this specific example, an antioxidant solution 16 is prepared according to an exemplary embodiment of the system 10 by combining an antioxidant 15 with water 40. As discussed above in relation to FIG. 1, antioxidant 15 prevents or minimizes lipid oxidation in lipid-rich, or high fatty acid product during cooking and storage. The added water 40 in this embodiment is used to facilitate the distribution of the antioxidant 15, particularly in the muscle tissue of the thawed product 12A. The added water can also contribute to removal of fatty acids, lipids and/or fats during the removal step (box 30 of FIG. 1) such that residual fatty acids, lipids and/or fats in the final product 12H (as shown in FIG. 8B) can be minimized after the cooking step (box 26), the chilling step (box 28) and the removal step (box 30). Further, the appropriate concentration of the antioxidant solution 16 can be evaluated by determining the amount of residual antioxidant solution 16 remained in the product following the cooking (box 26), chilling (box 28) and removal (box 30) steps.

In this specific example in FIG. 3, the antioxidant solution 16 is a Kalsec Duralox® 62.207.13 solution at about 2.5% that is utilized for the antioxidant treatment (box 20 of FIG. 1), though other antioxidant solutions 16 are possible. In exemplary embodiments, the antioxidant 15 can be combined with water 40 at a concentration of about 0% to about 10%, though other concentrations are possible. The antioxidant 15 could be natural or synthetic, water or oil soluble, colorless or with color, and can have certain flavor or be flavorless. In further embodiments, additional additives could be included such as salt, sugar or any other ingredients that could be used as a carrier.

In those embodiments in which the antioxidant solution 16 used in the process is Kalsec Duralox® 62.207.13 at a concentration of 2.5%, after the removal step (box 30 of FIG. 1) the resulting antioxidant concentration in the pressed product 12F is around 0.15%. Alternatively, any other known initial and final concentrations of antioxidant 15 and antioxidant solution can be achieved. As would be apparent to a skilled artisan, upper limits can be determined by flavor acceptance and lower limits determined by the effectiveness

As discussed above, FIGS. 4A and 4B depict one exemplary embodiment of the step of treating the product by transferring the thawed product and antioxidant solution to a tumbler (box 20 of FIG. 1). That is, in FIG. 4, the antioxidant solution 16 is added to the thawed product 12A in the treatment step (box 20). During the treatment step (box 20), the thawed product 12A is treated with the antioxidant solution 16 so as to be distributed throughout the thawed product 12A by physical agitation and/or infusion. For example, in various embodiments, the thawed product 12A and antioxidant solution 16 are tumbled in a tumbler 22.

In exemplary embodiments utilizing a tumbler 22, such as that of FIGS. 4A-B, the antioxidant solution 16 and thawed product 12A are vacuum tumbled for approximately 5 minutes at approximately 3 revolutions per minute (“RPM”), or until the antioxidant solution 16 is well incorporated into the treated product 12B. In these embodiments, a combination of the physical tumbling movement, the vacuum and diffusion promote the distribution of antioxidant solution 16 throughout the thawed product 12A. The use of a vacuum in the tumbling process facilitates the absorption of solutions as well as prevents the development of foam during the mechanical action of a protein.

In alternative embodiments, the product 12A can be treated (box 20) using any other known devices or equipment, such as mixers, blenders, agitators, shakers, injectors, sprayers or other actions and forces such as hand mixing, shaking, rotating or vacuuming that can incorporate the antioxidant solution 16 into the thawed product 12A.

In various embodiments, the tumbling or mixing speed should be regulated such that the thawed product 12A is moved but is not damaged, or unnecessarily disrupted. For example, the speed should be ensure that the process does not break or otherwise disrupt the product, such as turning the tuna loins into small flakes. Accordingly, in certain embodiments, the tumbling speed can vary from approximately 0 to 23 RPM or more and the tumbling time could vary from approximately 0 to 1 hour or more.

Continuing with FIGS. 4A-B, in exemplary embodiments, the ratio of thawed product 12A and antioxidant solution 16 is about 3.0 to about 0.7, though other ratios are possible. At this ratio, it was determined that a sufficient quantity of antioxidant solution 16 was present to distribute the antioxidant to the thawed product 12A evenly.

In certain alternative implementations, in lieu of the antioxidant preparation step (box 18 of FIG. 1), antioxidant 15 can be added directly to the thawed product 12A and water 40 can be added later during the treatment step (box 20 of FIG. 1).

FIGS. 5A-5B depict one embodiment of the step of packing the treated product into packages (box 24 of FIG. 1). In this exemplary embodiment, the treated product 12B is vacuum packed to facilitate cooking and to remove oxygen, thereby minimizing lipid oxidation. In these embodiments, the treated product 12B containing antioxidant solution 16 is first portioned 42 as shown in FIG. 5A and then vacuum packed (box 24) in cook-in high oxygen barrier bags 44, such as 4 lb. pouches as shown in FIG. 5B, as would be appreciated by one of skill in the art. In alternative embodiments, the treated product 12B can also be prepared for cooking in alternative known pouches or bags, without vacuum-packing, or in alternative atmospheres such as nitrogen, carbon dioxide and the like. After it is prepared for cooking by packing (box 24), the treated and packaged product 12C can next undergo a cooking step (box 26 of FIG. 1). In various embodiments, alternative pouches or bags can be utilized; however, it is critical that the oxygen level either be removed via vacuum or modified by atmosphere modification with appropriate gases.

Exemplary embodiments of the oxidation minimization system 10 employ a cooking step (box 26 of FIG. 1). As is shown in FIGS. 6A-6C according to one exemplary implementation of such a cooking step (box 26), treated and vacuum-packed product 12C is ready to cook. Under anaerobic conditions, Clostridium botulinum can grow in food product and produce toxins responsible for botulism. One known strategy for combating Clostridium botulinum is heat treatment. Clostridium botulinum type B is the most heat-resistant form of non-proteolytic C. botulinum, and the heat destruction guideline for C. botulinum type B is to achieve a “6D process,” which is a term known in the art. For example, heating tuna loins at 194 F for 10 min in a water bath 52 is to sufficient to achieve the 6D process for C. botulinum type B, and the 204° F. water is to provide a 10° F. delta, so the desired texture of tuna loins can be obtained within approximately 4 hours of cooking time. 6D thermal kill is a well established process. In short, cooking too long will result in the development of a “pot roast” type texture or extremely dry texture. A skilled artisan would appreciate that the desired implementation is to cook for sufficient time to achieve the 6D process but not excessively.

Accordingly, in the embodiment of FIGS. 6A-C, a water tank 50 is provided as best shown in FIG. 6B so that the treated and packaged product 12C (as shown in FIG. 6A) can be cooked in a water bath 52 (depicted in FIG. 6C) until a specified internal temperature is achieved. More specifically, in exemplary embodiments, and as shown in FIG. 6C, the treated and vacuum-packed product 12C is cooked in a water bath 52. The water bath 52 can be set at approximately 204° F., such that the packaged product 12C reaches a desired 194° F., and is then held at 194° F. for 10 min until it is cooked product 12D. Alternatively, the water bath 52 can be set at a temperature ranging from about 204° F. to about 208° F.—depending on the location altitude.

Other configurations and cooking methods are possible, such as by using any other heating devices that can achieve the required C. botulinum type B lethality or temperature and time combinations required for 6D process validation. Alternatively, any known range of temperatures, pressures and/or time periods for 6D process can be used, and any known temperatures, pressures and/or time periods can be applied for completing the cooking process to achieve the target lethality.

In exemplary embodiments, the chilling step (box 28 of FIG. 1) is used to prevent microbial growth and maintain desired product quality after cooking. FIG. 7A depicts one embodiment of a chilling step (box 28). As is shown in FIG. 7A, after cooking, the cooked product 12D can be chilled (box 28) to approximately 40° F. In these embodiments, the cooked product 12D can be chilled (box 28) in a water-ice bath 60 to bring the temperature of the cooked tuna loins from approximately 120 to approximately 55° F. within approximately 6 hours, and then continue to chill to approximately 40° F. Alternatively, the cooked product 12D can be chilled to a temperature ranging from less than about 40° F. and above about 32° F. In alternative embodiments, the cooked product 12D can be chilled (box 28) following other known procedures which meet food safety guidelines, such as using forced air, a freezer or a blast freezer.

After the chilling step (box 28 of FIG. 1), the antioxidant solution is removed by pressing or centrifugation (box 30). In one exemplary embodiment as shown in FIG. 7B, a removal step (box 30) is performed. The removal step (box 30) serves to minimize the amount of undesired fatty acids, fats, and/or lipids from chilled product 12E to produce pressed product 12F. The removal step (box 30) is important to minimizing lipid oxidation, and it is performed to remove these undesired fatty acids, fats, and/or lipids.

In certain embodiments of the system 10, the chilled product 12E can be pressed or centrifuged to remove the antioxidant solution 16. Other physical forces well known in the art may also be employed, such as a “salad spinner,” or other known techniques using mechanical or other known processes for removing excess liquid from a substance.

Continuing with FIG. 7B, in exemplary processes, a removal rate in excess of 60% of the antioxidant solution 16 can be achieved in the pressed product 12F. For example, in certain examples, approximately 71.82% was removed, based on the concentration of the antioxidant solution 16 and the target final concentration of the antioxidant in the resulting pressed product 12F.

After removal of the antioxidant solution (box 30 of FIG. 1), one optional step is to mix the cooked product with any additional ingredients (box 32). For example, FIG. 8A depicts an optional mixing step wherein the pressed product 12F is combined with further ingredients, such as mayonnaise 34. In these embodiments, a variety of mixing devices and methods may be employed, such as a tumbler, a mixer or hand mixing.

Following the removal step (box 30 of FIG. 1) or mixing step (box 32), certain embodiments of the system 10 next employ an optional final packing step (box 36). In the final packing step (box 36), the pressed product 12F or mixed product 12G is again vacuum packed into high oxygen barrier bags, or pouches, such as 2.5 lb. pouches 44B to produce a final product 12H, as is shown in FIG. 8B. The pressed product 12F or mixed product 12G can also be packed under other modified atmospheres such as nitrogen, carbon dioxide and the like. Further, other known packages or containers can be used.

As is also shown in FIG. 8B, exemplary embodiments of the system 10 also utilize an optional high pressure pasteurization (“HPP”) step (box 38 of FIG. 1) on the packed and final product 12H. HPP treatment enables this product to be stored in a refrigerated state with acceptable oxidation levels for up to 120 days. This length of storage not possible without HPP. In these embodiments, HPP can be performed on the final product 12H. HPP has become an alternative way to achieve food-safety requirements in ready-to-eat products, and is known in the art. Briefly, the pressure is transmitted to the final product 12H instantaneously and uniformly. In exemplary embodiments, the final product 12H is submerged in an enclosed vessel filled with liquid and the pressure is generated by either pumping more liquid to the vessel or reducing the volume of the vessel. In various embodiments, HPP inactivates microorganisms by interrupting their cellular functions including changing in the cell membranes, cell wall, proteins and enzyme-mediated cellular functions, as a result, cell structures and membranes are disrupted leading to inactivating of the microorganisms. Accordingly, the pasteurization step (box 38 of FIG. 1) is utilized to inhibit the growth of any residual microorganisms and to extend the shelf life in the final product 12H.

In exemplary embodiments, and as shown in FIG. 8B, the final product 12H undergoes the pasteurization step (box 38 of FIG. 1) at approximately 85,000 pounds per square inch (“PSI”) for approximately 200 seconds. In alternative embodiments of the system 10, the final product 12H can be treated with alternative other HPP conditions, including different pressure and time combinations, that can prolong the shelf life of the product, including by treating with any other processing that can prolong the shelf life of the product, such as omega heating, irradiation, UV light pasteurization, steam and the like.

Although the disclosure has been described with reference to preferred embodiments, persons skilled in the art will recognize that changes may be made in form and detail without departing from the spirit and scope of the disclosed apparatus, systems and methods.

What is claimed is:

1. A method for minimizing lipid oxidation in a food product, comprising:
a. preparing an antioxidant solution;
b. treating the food product with the antioxidant solution so as to mix the antioxidant solution into the product; and
c. removing excess antioxidant solution from the product,
wherein the treated product is vacuum-packed and cooked prior to removing excess antioxidant solution from the product.

2. The method of claim 1, wherein the antioxidant solution is a Kalsec Duralox® 62.207.13 antioxidant solution at about 2.5%.

3. The method of claim 1, the antioxidant solution comprising an antioxidant concentration in water of about 0% to about 10%.

4. The method of claim 1, wherein the treated product is portioned and vacuum packed in cook-in high oxygen barrier bags.

5. The method of claim 1, further comprising placing the product in a water bath at about 204°, such that the product reaches about 194° and is held at about 194° for about 10 min.

6. The method of claim 1, further comprising chilling the product after cooking in a water bath to bring the temperature of the product from about 120° to about 55° within about 6 hours and then continued to chill until the product reaches about 40°.

7. The method of claim 1, further comprising chilling the product, after cooking, is chilled to below 40° but above 32°.

8. The method of claim 1, further comprising adding an ingredient to the product.

9. A method for minimizing lipid oxidation in a food product, comprising:
a. treating the food product with an antioxidant solution;
b. mixing the antioxidant solution into the product; and
c. removing excess antioxidant solution from the product,
wherein the product is treated with the antioxidant throughout.

10. The method of claim 9, wherein the mixing tumbles the food product and antioxidant solution in a tumbler.

11. The method of claim 10, further comprising vacuum tumbling the antioxidant and thawed product for about 5 minutes at about 3 RPM.

12. The method of claim 9, wherein the food product to antioxidant solution ratio is about 3.0 to about 0.7.

13. The method of claim 9, wherein undiluted antioxidant is directly added to the product and water is added subsequently.

14. A method for minimizing lipid oxidation in a food product via several steps, the steps comprising:
a. preparing an antioxidant solution;
b. treating the food product with the antioxidant solution;
c. mixing the antioxidant solution into the product; and
d. removing excess antioxidant solution from the product.

15. The method of claim 14, wherein the removing comprises removing excess antioxidant solution from the product by mechanical force.

16. The method of claim 15, wherein the removing excess antioxidant is achieved by pressing the product, centrifuging the product or employing a “salad spinner” to mix the product.

17. The method of claim 14, further comprising vacuum packing the product into high oxygen barrier bags to produce a final product.

18. The method of claim 14, wherein the product is packed under a modified atmosphere.

19. A method for minimizing lipid oxidation in a food product via several steps, the steps comprising:
a. preparing an antioxidant solution;
b. treating the food product with the antioxidant solution;
c. mixing the antioxidant solution into the product;
d. removing excess antioxidant solution from the product; and
e. prolonging the shelf-life of the product.

20. The method of claim 19, wherein the step prolonging the product shelf-life consists of at least one finishing process selected from the group consisting of: pasteurizing the product, omega heating the product, irradiating the product, UV light pasteurizing the product and steam treating the product.
